(19) United States
(12) Patent Application Publication
(10) Pub. No.: US 2025/0258692 A1
(43) Pub. Date: Aug. 14, 2025

(54) Verification of Containers by Host Computing System

(71) Applicant: Telefonaktiebolaget LM Ericsson {publ}, Stockholm (SE)

(72) Inventors: Henrik Normann, Malmö (SE); Lina Pålsson, Genarp (SE); Mikael Eriksson, Alingsås (SE); Bernard Smeets, Dalby (SE); Stere Preda, Longueuil (CA); Daniel Migault, Montreal (CA)

(21) Appl. No.: 18/854,835

(22) PCT Filed: Oct. 28, 2022
(86) PCT No.: PCT/EP2022/080206

§ 371 Date: Oct. 7, 2024

Related U.S. Application Data
(60) Provisional application No. 63/346,163, filed on May 26, 2022.

(51) Int. Cl. G06F 9/455

(52) U.S. Cl. CPC G06F 9/45558; G06F 2009/45591; G06F 2009/45595

(57) ABSTRACT

Embodiments include methods for a software integrity tool of a host computing system configured with a runtime environment arranged to execute containers that include applications. Such methods include, based on an identifier of a container instantiated in the runtime environment, obtaining a container locator tag associated with the container and performing measurements on a filesystem associated with the container. Such methods include sending, to an attestation verification system (AVS), a representation of the container locator tag and a result of the measurements. Other embodiments include complementary methods for the container and for the AVS, as well as host computing systems configured to perform such methods.

### TECHNICAL FIELD

The present application relates generally to the field of communication networks, and more specifically to techniques for virtualization of network functions (NFs) using container-based solutions that execute in a host computing system (e.g., cloud, data center, etc.).

### INTRODUCTION

At a high level, the 5G System (5GS) consists of an Access Network (AN) and a Core Network (CN). The AN provides UEs connectivity to the CN, e.g., via base stations such as gNBs or ng-eNBs described below. The CN includes a variety of Network Functions (NF) that provide a wide range of different functionalities such as session management, connection management, charging, authentication, etc.

FIG. 1 illustrates a high-level view of an exemplary 5G network architecture, consisting of a Next Generation Radio Access Network (NG-RAN) 199 and a 5G Core (5GC) 198. NG-RAN 199 can include one or more gNodeB's (gNBs) connected to the 5GC via one or more NG interfaces, such as gNBs 100, 150 connected via interfaces 102, 152, respectively. More specifically, gNBs 100, 150 can be connected to one or more Access and Mobility Management Functions (AMFs) in the 5GC 198 via respective NG-C interfaces. Similarly, gNBs 100, 150 can be connected to one or more User Plane Functions (UPFs) in 5GC 198 via respective NG-U interfaces. Various other network functions (NFs) can be included in the 5GC 198, as described in more detail below.

In addition, the gNBs can be connected to each other via one or more Xn interfaces, such as Xn interface 140) between gNBs 100 and 150. The radio technology for the NG-RAN is often referred to as “New Radio” (NR). With respect the NR interface to UEs, each of the gNBs can support frequency division duplexing (FDD), time division duplexing (TDD), or a combination thereof. Each of the gNBs can serve a geographic coverage area including one or more cells and, in some cases, can also use various directional beams to provide coverage in the respective cells.

NG-RAN 199 is layered into a Radio Network Layer (RNL) and a Transport Network Layer (TNL). The NG-RAN logical nodes and interfaces between them are part of the RNL, while the TNL provides services for user plane transport and signaling transport. TNL protocols and related functionality are specified for each NG-RAN interface (e.g., NG, Xn, F1).

The NG-RAN logical nodes shown in FIG. 1 include a Central Unit (CU or gNB-CU) and one or more Distributed Units (DU or gNB-DU). For example, gNB 100 includes gNB-CU 110 and gNB-DUs 120 and 130. CUs (e.g., gNB-CU 110) are logical nodes that host higher-layer protocols and perform various gNB functions such controlling the operation of DUs. A DU (e.g., gNB-DUs 120, 130) is a decentralized logical node that hosts lower layer protocols and can include, depending on the functional split option, various subsets of the gNB functions. As such, each of the CUS and DUs can include various circuitry needed to perform their respective functions, including processing circuitry, transceiver circuitry (e.g., for communication), and power supply circuitry.

A gNB-CU connects to one or more gNB-DUs over respective F1 logical interfaces, such as interfaces 122 and 132 shown in FIG. 1. However, a gNB-DU can be connected to only a single gNB-CU. The gNB-CU and connected gNB-DU(s) are only visible to other gNBs and the 5GC as a gNB. In other words, the F1 interface is not visible beyond gNB-CU.

Conventionally, telecommunication equipment was provided as integrated software and hardware. More recently, virtualization technologies decouple software and hardware such that network functions (NFs) can be executed on commercial off-the-shelf (COTS) hardware. For example, mobile networks can include virtualized network functions (VNFs) and non-virtualized network elements (NEs) that perform or instantiate a NF using dedicated hardware. In the context of the exemplary 5G network architecture shown in FIG. 1, various NG-RAN nodes (e.g., CU) and various NFs in 5GC can be implemented as combinations of VNFs and NEs.

In some cases, NFs can be obtained from a vendor as packaged in “containers,” which are software packages that can run on commercial off-the-shelf (COTS) hardware. A computing infrastructure provider (e.g., hyperscale provider, communication service provider, etc.) typically provides resources to vendors for executing their containers. These resources include computing hardware as well as a software environment that hosts or executes the containers, which is often referred to as a “runtime environment” or more simply as “runtime”.

For example, Docker is a popular container runtime that runs on various Linux and Windows operating systems (OS). Docker creates simple tooling and a universal packaging approach that bundles all application dependencies inside a container to be run in a Docker Engine, which enables containerized applications to run consistently on any infrastructure.

### SUMMARY

Currently, when a runtime such as Docker instantiates a container holding a software image (e.g., of a NF), there is no way to verify that the runtime actually instantiates what was intended. This can cause various problems, issues, and/or difficulties, such as an inability to detect flaws in or attacks on the software image.

Embodiments of the present disclosure address these and other problems, issues, and/or difficulties, thereby facilitating more efficient use of runtimes that host containerized software, such as virtual NFs of a communication network.

Some embodiments include exemplary methods (e.g., procedures) for a software integrity tool of a host computing system configured with a runtime environment arranged to execute containers that include applications.

These exemplary methods can include, based on an identifier of a container instantiated in the runtime environment, obtaining a container locator tag associated with the container and perform measurements on a filesystem associated with the container. These exemplary methods can also include sending, to an attestation verification system (AVS), a representation of the container locator tag and a result of the measurements.

In some embodiments, these exemplary methods can also include monitoring for one or more events or patterns indicating that a container has been instantiated in the runtime environment and, in response to detecting the one or more events or patterns, obtaining the identifier of the container that has been instantiated. In some of these embodiments, monitoring for the one or more events can be performed using an eBPF probe.

In some embodiments, performing measurements on the filesystem includes computing a digest of one or more files stored in the filesystem associated with the container. In such case, the result of the measurements is the digest. In some of these embodiments, performing measurements on the filesystem can also include selecting the one or more files on which to compute the digest according to a digest policy of the host computing system.

In some embodiments, the identifier associated with the container is a process identifier (PID), and the filesystem associated with the container has a pathname that includes the PID. In some embodiments, the container locator tag is a random string. In some embodiments, the container locator tag is obtained from a predefined location in the filesystem associated with the container. In some embodiments, the representation of the container locator tag is one of the following: the container locator tag, or a digest of the container locator tag.

In some embodiments, these exemplary methods can also include digitally signing the representation of the container locator tag and the result of the measurements before sending to the AWS. In such case, the digital signing is based on key material that is accessible to the host computing system but is not accessible to containers configured to execute in the runtime environment. This restriction can prevent false self-attestation by the containers. In some of these embodiments, the digital signing is performed by a Hardware-Mediated Execution Enclave (HMEE) associated with the software integrity tool.

Other embodiments include exemplary methods (e.g., procedures) for a container that includes an application and that is configured to execute in a runtime environment of a host computing system.

These exemplary methods can include, in response to the container being instantiated in the runtime environment, generating a container locator tag and storing the container locator tag in association with the container. The exemplary method can also include subsequently receiving, from an AVS, an attestation result indicating whether the AVS verified the filesystem associated with the container based on measurements made by a software integrity tool of the host computing system. These exemplary methods can also include, when the attestation result indicates that the AVS verified the filesystem associated with the container, preparing the application for execution in the runtime environment of the host computing system.

In some embodiments, the container also includes an attest client, which generates and stores the container locator tag and receives the attestation result.

In some embodiments, these exemplary methods can also include performing one or more of the following when the attestation result indicates that the AVS did not verify the filesystem associated with the container: error handling, and refraining from preparing the application for execution in the runtime environment.

In some embodiments, the container locator tag is a random string. In some embodiments, the container locator tag is stored in a predefined location in the filesystem associated with the container.

In some embodiments, these exemplary methods can also include sending a representation of the container locator tag to an AVS. In such case, the received attestation result is based on the representation of the container locator tag. In some of these embodiments, the representation of the container locator tag is one of the following: the container locator tag, or a digest of the container locator tag.

In some embodiments, the measurement results include a digest of one or more files stored in the filesystem associated with the container. In some of these embodiments, the one or more files are based on a digest policy of the host computing system.

Other embodiments include exemplary methods (e.g., procedures) for an AVS associated with a host computing system configured with a runtime environment arranged to execute containers that include applications.

These exemplary methods can include receiving the following from a software integrity tool of the host computing system: a representation of a container locator tag for a container instantiated in the runtime environment, and results of measurements performed by the software integrity tool on a filesystem associated with the container. These exemplary methods can also include, based on detecting a match between the representation of the container locator tag and a previously received representation of the container locator tag, performing a verification of the filesystem associated with the container based on the results of the measurements. These exemplary methods can also include sending to the container an attestation result indicating whether the AVS verified the filesystem associated with the container.

In some embodiments, performing the verification can include comparing the results of the measurements with one or more known-good or reference values associated with the container and verifying the filesystem only when there is a match or correspondence between the results of the measurements and the one or more known-good or reference values.

In some embodiments, the previously received representation was received from an attest client included in the container. In some embodiments, the container locator tag is a random string. In some embodiments, the container locator tag is stored in a predefined location in the filesystem associated with the container. In some embodiments, the representation of the container locator tag is one of the following: the container locator tag, or a digest of the container locator tag.

In some embodiments, the representation of the container locator tag and the result of the measurements are digitally signed by the software integrity tool. In such embodiments, performing the verification includes verifying the digital signing based on key material that is accessible to the host computing system but is not accessible to containers configured to execute in the runtime environment.

Other embodiments include software integrity tools, containers, AVS, and/or host computing systems configured to perform the operations corresponding to any of the exemplary methods described herein. Other embodiments also include non-transitory, computer-readable media storing computer-executable instructions that, when executed by processing circuitry of a host computing system or an AVS, configure the host computing system or the AVS to perform operations corresponding to any of the exemplary methods described herein.

These and other disclosed embodiments can facilitate verification that a container is started with the expected filesystem, e.g., by verifying the integrity of the binary image and library files. Since this verification operates at the host level, it is independent of the container. This verification can also be independent from the container runtime (e.g., Docker), which is advantageous if/when an attack originates from the container runtime software. At a high level, embodiments performing verification at the host level provide better security than verification performed within the container, since it prevents a container from false self-attestation.

These and other objects, features, and advantages of the present disclosure will become apparent upon reading the following Detailed Description in view of the Drawings briefly described below.

### BRIEF DESCRIPTION OF THE DRAWINGS

FIG. 1 shows an exemplary 5G network architecture.

FIG. 2 shows an exemplary Network Function Virtualisation Management and Orchestration (NFV-MANO) architectural framework for a 3GPP-specified network.

FIG. 3 shows an exemplary high-level architecture for a Docker Engine.

FIG. 4 shows an example computing configuration that uses the Docker Engine shown in FIG. 3.

FIG. 5 shows an example implementation of eBPF in a Linux operating system (OS) kernel.

FIG. 6 shows a flow diagram for high-level operation of a software integrity tool, according to some embodiments of the present disclosure.

FIG. 7 shows an exemplary signaling diagram for a verification procedure for a container executed by a host computing system, according to some embodiments of the present disclosure.

FIG. 8 shows an exemplary method (e.g., procedure) for a software integrity tool configured to execute in a host computing system that is arranged to execute containerized applications, according to various embodiments of the present disclosure.

FIG. 9 shows an exemplary method (e.g., procedure) for a container configured to execute in a host computing system, according to various embodiments of the present disclosure.

FIG. 10 shows an exemplary method (e.g., procedure) for an AVS associated with host computing system configured to execute containerized applications, according to various embodiments of the present disclosure.

FIG. 11 is a block diagram illustrating an exemplary container-based host computing system suitable for implementation of various embodiments described herein.

### DETAILED DESCRIPTION

Embodiments briefly summarized above will now be described more fully with reference to the accompanying drawings. These descriptions are provided by way of example to explain the subject matter to those skilled in the art and should not be construed as limiting the scope of the subject matter to only the embodiments described herein. More specifically, examples are provided below that illustrate the operation of various embodiments according to the advantages discussed above.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods and/or procedures disclosed herein do not have to be performed in the exact order disclosed, unless a step is explicitly described as following or preceding another step and/or where it is implicit that a step must follow or precede another step. Any feature of any of the embodiments disclosed herein can be applied to any other embodiment, wherever appropriate. Likewise, any advantage of any of the embodiments can apply to any other embodiments, and vice versa. Other objects, features and advantages of the disclosed embodiments will be apparent from the following description.

Note that the description given herein focuses on a 3GPP telecommunications system and, as such, 3GPP terminology or terminology similar to 3GPP terminology is generally used. However, the concepts disclosed herein are not limited to a 3GPP system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from the concepts, principles, and/or embodiments described herein.

In addition, functions and/or operations described herein as being performed by a telecommunications device or a network node may be distributed over a plurality of telecommunications devices and/or network nodes.

As briefly discussed above, virtualization technologies decouple software and hardware such that network functions (NFs) can be executed on commercial off-the-shelf (COTS) hardware. ETSI GR NFV 001 (v1.3.1) published by the European Telecommunications Standards Institute (ETSI) describes various high-level objectives and use cases for network function virtualization (NFV). The high-level objectives include the following:
Rapid service innovation through software-based deployment and operationalization of network functions and end-to-end services.
Improved operational efficiencies resulting from common automation and operating procedures.
Reduced power usage achieved by migrating workloads and powering down unused hardware.
Standardized and open interfaces between network functions and their management entities so that such decoupled network elements can be provided by different entities.
Greater flexibility in assigning VNFs to hardware.
Improved capital efficiencies compared with dedicated hardware implementations.

Similarly, the various NFV use cases described in ETSI GR NFV 001 can be divided roughly into the following groups or categories:
Virtualization of telecommunication networks.
Virtualization of services in telecommunication networks, e.g., Internet-of-Things (IoT) virtualization, enhanced security, network slicing, etc.
Improved operation of virtualized networks, e.g., rapid service deployment, continuous integration/continuous deployment (CI/CD), testing and verification, etc.

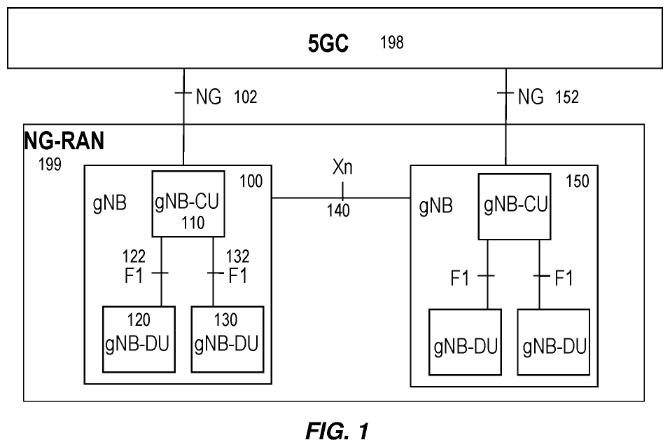

For example, mobile or cellular networks can include virtualized NFs (VNFs) and non-virtualized network elements (NEs) that perform or instantiate a NF using dedicated hardware. In the context of the exemplary 5G network architecture shown in FIG. 1, various NG-RAN nodes (e.g., CU) and various NFs in 5GC can be implemented as combinations of VNFs and NEs.

In general, a (non-virtual) NE can be considered as one example of a physical network function (PNF). From a high-level perspective, a VNF is equivalent to the same NF realized by an NE. However, the relation between NE and VNF instances depends on the relation between the corresponding NFs. A NE instance is 1:1 related to a VNF instance if the VNF contains the entire NF of the NE. Even so, multiple instances of a VNF may run on the same NF virtualization infrastructure (NFVI, e.g., cloud infrastructure, data center, etc.).

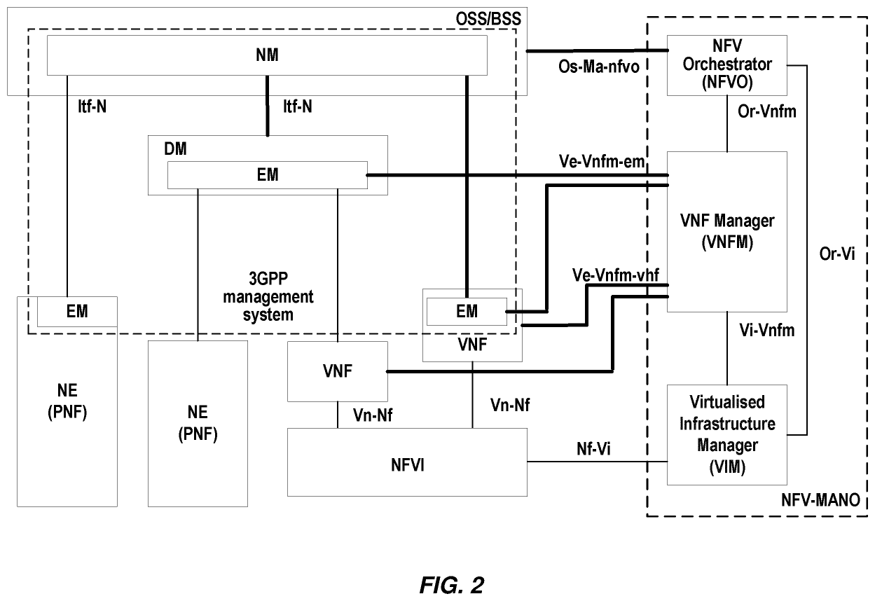

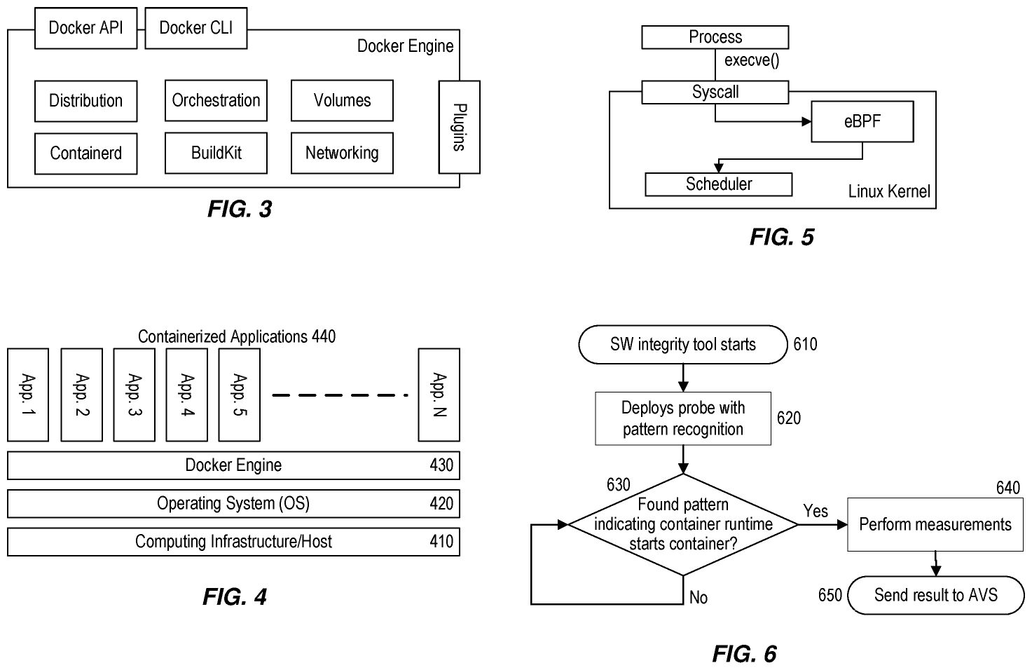

Both VNFs and NEs need to be managed in a consistent manner. To facilitate this, 3GPP specifies a Network Function Virtualisation Management and Orchestration (NFV-MANO) architectural framework. FIG. 3 shows an exemplary mobile network management architecture mapping relationship between NFV-MANO architectural framework and other parts of a 3GPP-specified network. The arrangement shown in FIG. 2 is described in detail in 3GPP TS 28.500 (v17.0.0) section 6.1, the entirety of which is incorporated herein by reference. Certain portions of this description are provided below for context and clarity.

The architecture shown in FIG. 2 includes the following entities, some of which are further defined in 3GPP TS 32.101 (v17.0.0):
Network Management (NM), which plays one of the roles of operation support system (OSS) or business support system (BSS) and is the consumer of reference point Os-Ma-nfvo;
Device Management (DM)/Element Management (EM), if the EM includes the extended functionality, it can manage both PNFs and VNFs;
NFV Orchestrator (NFVO);
VNF Manager (VNFM);
Virtualized infrastructure manager (VIM);
Itf-N, interface between NM and DM/EM;
Os-Ma-nfvo, reference point between OSS/BSS and NFVO;
Ve-Vnfm-em, reference point between EM and VNFM;
Ve-Vnfm-vnf, reference point between VNF and VNFM; and
NFVI, the hardware and software components that together provide the infrastructure resources where VNFs are deployed.

EM/DM is responsible for FCAPS (fault, configuration, accounting, performance, security) management functionality for a VNF on an application level and NE on a domain and element level. This includes:
Fault management for VNF and physical NE.
Configuration management for VNF and physical NE.
Accounting management for VNF and physical NE.
Performance measurement and collection for VNF and physical NE.
Security management for VNF and physical NE.
VNF lifecycle management (LCM), such as requesting LCM for a VNF by VNFM and exchanging information about a VNF and virtualized resources associated with a VNF.

In some cases, NFs can be obtained from a vendor as packaged in “containers,” which are software packages that can run on COTS hardware. More specifically, a container is a standard unit of software that packages application code and all its dependencies so the application runs quickly and reliably in different computing environments. A computing infrastructure provider (e.g., hyperscale provider, communication service provider, etc.) typically provides resources to vendors for executing their containers. These resources include computing hardware as well as a software environment that hosts or executes the containers, which is often referred to as a “runtime.”

Docker is a popular container runtime that runs on various Linux and Windows operating systems (OS). Docker creates simple tooling and a universal packaging approach that bundles all application dependencies inside a container that is run on the Docker Engine. Specifically, Docker Engine enables containerized applications to run consistently on any infrastructure. A Docker container image is a lightweight, standalone, executable package of software with everything needed to run an application, including code, runtime, system tools, system libraries, and settings. Docker container images become containers at runtime, i.e., when the container images run on the Docker Engine. Multiple Docker containers can run on the same machine and share the OS kernel with other Docker containers, each running as isolated processes in user space.

FIG. 3 shows an exemplary high-level architecture for a Docker Engine, with various blocks shown in FIG. 3 described below.

Containerd implements a Kubernetes Container Runtime Interface (CRI) and is widely adopted across public clouds and enterprises. Kubernetes is a common platform used to provide cloud-based web-services. Kubernetes can coordinate a highly available cluster of connected computers (also referred to as “processing elements” or “hosts”) to work as a single unit. Kubernetes deploys applications packaged in containers (e.g., via its runtime) to decouple them from individual computing hosts.

In general, a Kubernetes cluster consists of two types of resources: a “master” that coordinates or manages the cluster and “nodes” or “workers” that run applications. Put differently, a node is a virtual machine (VM) or physical computer that serves as a worker machine. The master coordinates all activities in a cluster, such as scheduling applications, maintaining applications' desired state, scaling applications, and rolling out new updates. Each node has a Kubelet, which is an agent for managing the node and communicating with the Kubernetes master, as well as tools for handling container operations. The Kubernetes cluster master starts the application containers and schedules the containers to run on the cluster's nodes. The nodes communicate with the master using the Kubernetes API, which the master exposes. End users can also use the Kubernetes API directly to interact with the cluster.

A “pod” is a basic execution unit of a Kubernetes application, i.e., the smallest and simplest unit that can be created and deployed in the Kubernetes object model. A pod represents processes running on a cluster and encapsulates an application's container(s), storage resources, a unique network IP address, and options that govern how the container(s) should run. Put differently, a Kubernetes pod represents a single instance of an application, which can consist of one or more containers that are tightly coupled and that share resources.

Returning to FIG. 3, BuildKit is an open source tool that takes the instructions from a Dockerfile and builds (or creates) a Docker container image. This build process can take a long time so BuildKit provides several architectural enhancements that makes it much faster, more precise, and portable. The Docker Application Programming Interface (API) and the Docker Command Line Interface (CLI) facilitate interfacing with the Docker Engine. For example, the Docker CLI enables users to manage container instances through a clear set of commands.

As shown in FIG. 3, the Docker Engine also provides functions such as distribution, orchestration, and networking. The Docker Engine also provides volumes functionality, which is a preferred mechanism for persisting data generated and/or used by Docker containers. Compared to bind mounts, in which a file or directory on the host machine is mounted into a container, volumes are independent of the directory structure and OS of the host machine and are completely managed by Docker.

FIG. 4 shows an example computing configuration that uses the Docker Engine. At the bottom are the computing infrastructure (410, also referred to as “host”) that runs the OS (420, e.g., Windows, Linux, etc.). The Docker Engine (430) runs on top of the OS and executes applications I-N as Docker containers (440, also referred to as “containerized applications”).

Typically, the OS is the best place to implement observability, security, and networking functionality due to the OS kernel's privileged ability to oversee and control the entire system. At the same time, an OS kernel is difficult to evolve due to its central role and strict requirements for stability and security. Thus, the rate of innovation at OS level has been slower compared to innovation outside of the OS, such as Kubernetes, Docker Engine, etc.

eBPF is a technology that can run sandbox programs in the Linux OS kernel. In particular, eBPF is an easy and secure way to access the kernel without affecting its behavior. eBPF can also collect execution information without changing the kernel itself or by adding kernel modules. eBPF does not require altering the Linux kernel source code, nor does it require any particular Linux kernel modules in order to function. The technology is well suited for collecting information both from user space and kernel space via carefully placed probes.

eBPF programs are event-driven and are run when the kernel (or an application) passes a certain hook point. Pre-defined hooks include system calls, function entry/exit, kernel tracepoints, network events, etc. FIG. 5 shows an example implementation of eBPF in a Linux OS kernel, where a system call (Syscall) to the kernel scheduler is the hook that triggers eBPF program execution.

Currently, when a container runtime such as Docker Engine instantiates a container, there is no way to verify that the runtime actually instantiates what was intended. Some tools exist for measuring the container software image. One example is cosign, which provides container signing, verification and storage in an Open Container Initiative (OCI) registry. Also, some tools exist for detecting unexpected changes in a running container's filesystem. One example is Sysdig Monitor, which monitors Kubernetes pods, clusters, etc.

Currently, however, there is no way to verify that the original software image (e.g., of a NF) is actually running in the instantiated container. This can cause various problems, issues, and/or difficulties. For example, a flaw in, or an attack on, the container runtime software can cause changes in the usr directory of the running container and there is currently no structured way to discover such a flaw or attack.

Accordingly, embodiments of the present disclosure address these and other problems, issues, and/or difficulties by techniques that identify (e.g., using eBPF) that a certain container has been instantiated, which is done autonomously and/or independently from the container runtime environment (e.g., Docker). The techniques then perform software attestation (e.g., calculating a digest) on a set of files present within the container. For example, the computing host can detect when a new container is instantiated and then measure selected parts of that container's filesystem. The host then signs the measurement with a key only accessible to the host. The signed measurement can be verified and compared against a known-good value by a verification instance within the cluster. In some embodiments, the known-good value was previously calculated by a vendor of the container during container image creation and before delivering the container image to the intended user.

Embodiments described herein provide various benefits and/or advantages. For example, embodiments facilitate verification that a container is started with the expected filesystem, e.g., by verifying the integrity of the binary image and library files. Since this verification operates at the host level, it is independent of the container. This verification can also be independent from the container runtime (e.g., Docker), which is advantageous if/when an attack originates from the container runtime software. In other words, the verification is performed on the host (“bare-metal”) execution of the container, independent from the container runtime and the Kubernetes cluster. A further advantage is that the verification is independent of container vendor, since it utilizes functionality that plugs into each container. At a high level, embodiments operating at the host level provide better security than verification performed within the container, since it prevents a container from false self-attestation.

FIG. 6 shows a flow diagram for high-level operation of a software integrity tool, according to some embodiments of the present disclosure. In particular, the software integrity tool can run in a host computing environment that provides containerized execution of applications, such as described above. After the software integrity tool starts (block 610), it deploys a (software) probe with pattern recognition capability (block 620). The software probe continually looks for a pattern indicating that the container runtime (e.g., Docker) started a container (block 630). Once the software probe identifies such a pattern (“Yes” branch), it performs measurements (block 640) and sends the results to an attestation verification system (AVS) external to the host (block 650).

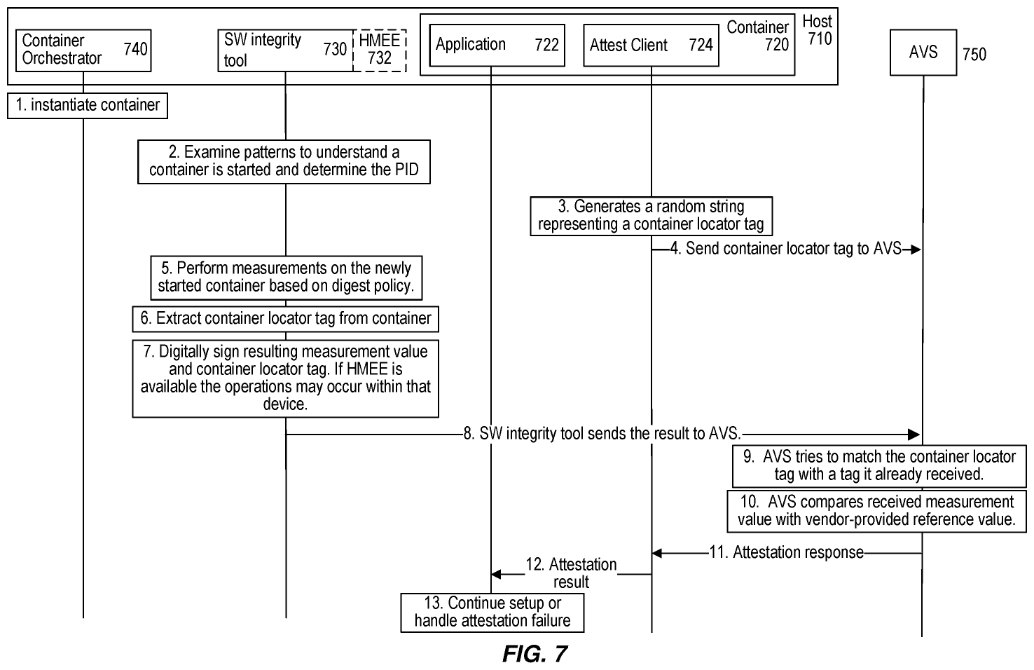

FIG. 7 shows an exemplary signaling diagram for a verification procedure for a container executed by a host computing system (“host”, 710), according to some embodiments of the present disclosure. Although the operations shown in FIG. 7 are given numerical labels, this is done to facilitate explanation rather than to require or imply a sequential order, unless stated to the contrary below.

As shown in FIG. 7, the host is arranged to execute a container (720) that includes an application (722) and an attest client (724). Additionally, the host is arranged to execute a software integrity tool (730) and a container orchestrator (740). In some cases, the software integrity tool may include or be associated with a Hardware-Mediated Execution Enclave (HMEE, 732), which provides hardware-enforced isolation of both code and data.

For example, an HMEE can act as a root of trust and can be used for attestation. In such a scenario, a remote verifier can request a quote from the HMEE, possibly via an attestation agent. The HMEE will provide signed measurement data (the “quote”) to the remote verifier. The remote verifier can then verify the signature and the quote with its own stored data. In this manner, HMEE-based attestation can provide the remote verifier with assurance of the right application executing on the right platform. HMEE is further specified in ETSI GR NFV-SEC 009.

As a prerequisite, the software integrity tool is running on the host, such as illustrated in FIG. 6. In operation 1, the orchestrator decides to instantiate a container instance originating from a container image. In operation 2, based on identifying a pattern at the system level, software integrity tool understands that a container runtime has initiated a container instance. The software integrity tool also identifies a process identifier (PID) associated with the container. For example, the PID may be a Docker PID, assigned by the Docker Engine.

The detection of a container start-up in operation 2 can be implemented in various ways. In some embodiments, eBPF can be used to detect the start of new processes and recognize a certain chain of started processes indicating the start of a new container. Such embodiments are independent of container runtime software, even if they may require adaptation to support different container runtime solutions. By using eBPF, these embodiments can efficiently detect start of a new container while being fail-safe and container independent. In other embodiments, functionality in the container runtime software can be used to detect the start of new containers and to achieve the PID of the container.

After the container has been instantiated, the attest client internal to the container generates a random container locator tag in operation 3. The length should be long enough to avoid collisions. The attest client stores the container locator tag in the container (e.g., at a predefined path) and, in operation 4, sends the container locator tag to an AVS (750). Alternately, the attest client can send data that enables identification of the container locator tag, such as a digest. Note that the AVS may be external to the host (as shown) or internal to the host.

After the software integrity tool has knowledge of the PID, it performs operations 5-7. In operation 5, the software integrity tool performs perform measurements on the newly started container's filesystem. For example, the software integrity tool can compute a digest of files in the container's file system. In some embodiments, a digest policy may specify which file system folders to include in the digest computation. The filesystem of the container measured in operation 5 can be fetched on different paths of the host. One place to fetch it from is/proc/[PID]/root. Another place to fetch it from is the driver of the container runtime.

In operation 6, the software integrity tool locates and reads the container locator tag from within the container, e.g., from the predefined path. In operation 7, the software integrity tool digitally signs the digest obtained in operation 5 and the container locator tag obtained in operation 6. If the software integrity tool includes or is associated with an HMEE, that can be used to provide additional security for handling of key material used for signing. In such case, only the host has access to the key needed to verify the source of the measurement.

In operation 8, the software integrity tool sends the signed measurement result to the AVS together with the signed container locator tag. In operation 9, the AVS attempts to match the container locator tag received in operation 8 with a tag it has received previously, e.g., in operation 4. In case there is no match or the AVS understands the container locator tag has recently been received e.g., a replay attack, the procedure would typically stop or transition into error handling. Alternately, if operation 8 occurs before operation 4, the AVS may attempt to match the later-received tag from the attest client with an earlier-received tag from the software integrity tool.

In operations 10-11, the AVS compares the received measurement value with a list of known-good values and responds to the attest client with the result, i.e., attestation success or failure. The AVS can locate the correct attest client with the help of the container locator tag, which maps to the sender of the message in operation 4. In operations 12-13, the container receives the result from the attest client and either continues container setup if attestation was successful or starts error handling if attestation failed.

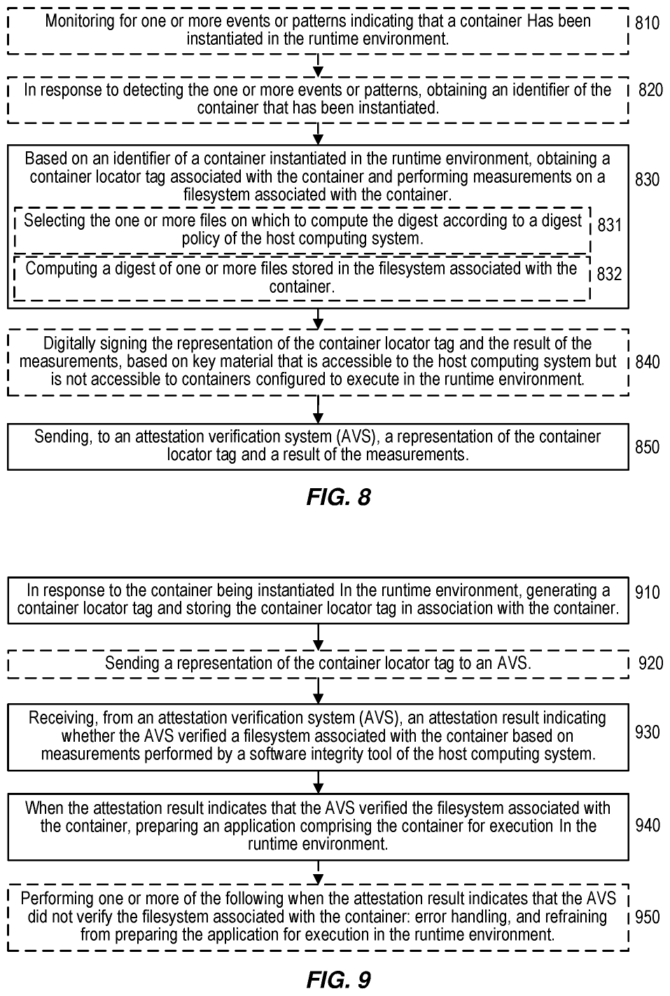

The embodiments described above can be further illustrated with reference to FIGS. 8-10, which depict exemplary methods (e.g., procedures) for software integrity tool, a container including an application, and an AVS, respectively. Put differently, various features of the operations described below correspond to various embodiments described above. The exemplary methods shown in FIGS. 8-10 can be used cooperatively (e.g., with each other and with other procedures described herein) to provide benefits, advantages, and/or solutions to problems described herein. Although the exemplary methods are illustrated in FIGS. 8-10 by specific blocks in particular orders, the operations corresponding to the blocks can be performed in different orders than shown and can be combined and/or divided into blocks and/or operations having different functionality than shown. Optional blocks and/or operations are indicated by dashed lines.

Specifically, FIG. 8 illustrates an exemplary method (e.g., procedure) for a software integrity tool of a host computing system configured with a runtime environment arranged to execute containers that include applications, according to various embodiments of the present disclosure. The exemplary method shown in FIG. 8 can be performed by a software integrity tool such as described elsewhere herein, or by a host computing system (“host”) that executes such a software integrity tool.

The exemplary method can include the operations of block 830, where based on an identifier of a container instantiated in the runtime environment, the software integrity tool can obtain a container locator tag associated with the container and perform measurements on a filesystem associated with the container. The exemplary method can also include the operations of block 850, where the software integrity tool can send, to an attestation verification system (AVS), a representation of the container locator tag and a result of the measurements.

In some embodiments, the exemplary method can include the operations of blocks 810-820, where the software integrity tool can monitor for one or more events or patterns indicating that a container has been instantiated in the runtime environment and, in response to detecting the one or more events or patterns, obtain the identifier of the container that has been instantiated. In some of these embodiments, monitoring for the one or more events in block 810 is performed using an eBPF probe.

In some embodiments, performing measurements on the filesystem in block 830 includes the operations of sub-block 832, where the software integrity tool can compute a digest of one or more files stored in the filesystem associated with the container. In such case, the result of the measurements is the digest. In some of these embodiments, performing measurements on the filesystem in block 830 also includes the operations of sub-block 831, where the software integrity tool can select the one or more files on which to compute the digest according to a digest policy of the host computing system.

In some embodiments, the identifier associated with the container is a process identifier (PID), and the filesystem associated with the container has a pathname that includes the PID. In some embodiments, the container locator tag is a random string. In some embodiments, the container locator tag is obtained (e.g., in block 830) from a predefined location in the filesystem associated with the container. In some embodiments, the representation of the container locator tag is one of the following: the container locator tag, or a digest of the container locator tag.

In some embodiments, the exemplary method can also include the operations of block 840, where the software integrity tool can digitally sign the representation of the container locator tag and the result of the measurements before sending to the AWS (e.g., in block 850). In such case, the digital signing is based on key material that is accessible to the host computing system but is not accessible to containers configured to execute in the runtime environment. This restriction can prevent false self-attestation by the containers. In some of these embodiments, the digital signing is performed by a Hardware-Mediated Execution Enclave (HMEE) associated with the software integrity tool.

In addition, FIG. 9) illustrates an exemplary method (e.g., procedure) for a container that includes an application and that is configured to execute in a runtime environment of a host computing system, according to various embodiments of the present disclosure. For example, the exemplary method shown in FIG. 9) can be performed by a container (e.g., Docker container, Kubernetes container, etc.) such as described elsewhere herein, or by a host computing system (“host”) that executes such a container in the runtime environment.

The exemplary method can include the operations of block 910, where in response to the container being instantiated in the runtime environment, the container can generate a container locator tag and store the container locator tag in association with the container. The exemplary method can also include the operations of block 930, where the container can subsequently receive, from an attestation verification system (AVS), an attestation result indicating whether the AVS verified the filesystem associated with the container based on measurements made by a software integrity tool of the host computing system. The exemplary method can also include the operations of block 940, where when the attestation result indicates that the AVS verified the filesystem associated with the container, the container can prepare the application for execution in the runtime environment of the host computing system.

In some embodiments, the container also includes an attest client, which generates and stores the container locator tag (e.g., in block 910) and receives the attestation result (e.g., in block 930). An example of this arrangement is shown in FIG. 7.

In some embodiments, the exemplary method can also include the operations of block 950, where the container can perform one or more of the following when the attestation result indicates that the AVS did not verify the filesystem associated with the container: error handling, and refraining from preparing the application for execution in the runtime environment.

In some embodiments, the container locator tag is a random string. In some embodiments, the container locator tag is stored (e.g., in block 910) in a predefined location in the filesystem associated with the container.

In some embodiments, the exemplary method can also include the operations of block 920, where the container can send a representation of the container locator tag to an AVS. In such case, the attestation result (e.g., received in block 930) is based on the representation of the container locator tag. In some of these embodiments, the representation of the container locator tag is one of the following: the container locator tag, or a digest of the container locator tag.

In some embodiments, the measurement results include a digest of one or more files stored in the filesystem associated with the container. In some of these embodiments, the one or more files are based on a digest policy of the host computing system.

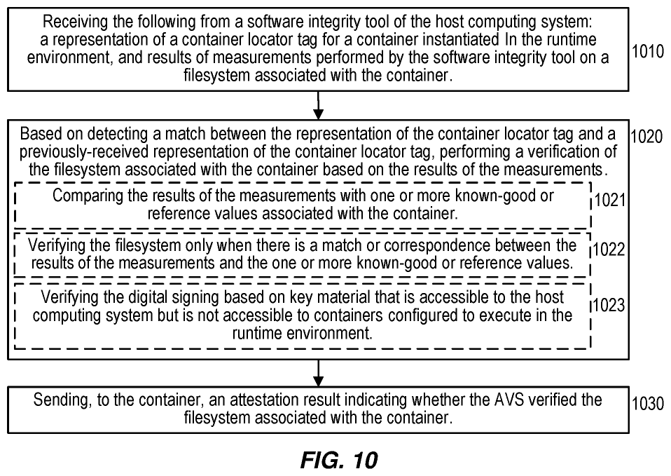

In addition, FIG. 10 illustrates an exemplary method (e.g., procedure) for an AVS associated with a host computing system configured with a runtime environment arranged to execute containers that include applications, according to various embodiments of the present disclosure. For example, the exemplary method shown in FIG. 10 can be performed by an AVS such as described elsewhere herein, or by a host computing system (“host”) that executes such an AVS.

The exemplary method can include the operations of block 1010, where the AVS can receive the following from a software integrity tool of the host computing system: a representation of a container locator tag for a container instantiated in the runtime environment, and results of measurements performed by the software integrity tool on a filesystem associated with the container. The exemplary method can also include the operations of block 1020, where based on detecting a match between the representation of the container locator tag and a previously received representation of the container locator tag, the AVS can perform a verification of the filesystem associated with the container based on the results of the measurements. The exemplary method can also include the operations of block 1020, where the AVS can send to the container an attestation result indicating whether the AVS verified the filesystem associated with the container.

In some embodiments, performing the verification in block 1020 can include the operations of sub-blocks 1021-1022, where the AVS can compare the results of the measurements with one or more known-good or reference values associated with the container and verify the filesystem only when there is a match or correspondence between the results of the measurements and the one or more known-good or reference values. For example, the known-good or reference values can be provided by a vendor of the containerized application, such as discussed above.

In some embodiments, the previously received representation was received from an attest client included in the container. In some embodiments, the container locator tag is a random string. In some embodiments, the container locator tag is stored in a predefined location in the filesystem associated with the container. In some embodiments, the representation of the container locator tag is one of the following: the container locator tag, or a digest of the container locator tag.

In some embodiments, the representation of the container locator tag and the result of the measurements are digitally signed by the software integrity tool. In such embodiments, performing the verification in block 1020 also includes the operations of sub-block 1023, where the AVS can verify the digital signing based on key material that is accessible to the host computing system but is not accessible to containers configured to execute in the runtime environment.

Although FIGS. 8-10 describe methods (e.g., procedures), the operations corresponding to the methods (including any blocks and sub-blocks) can also be embodied in a non-transitory, computer-readable medium storing computer-executable instructions. The operations corresponding to the methods (including any blocks and sub-blocks) can also be embodied in a computer program product storing computer-executable instructions. In either case, when such instructions are executed by processing circuitry associated with a host computing system, they can configure the host computing system (or components thereof) to perform operations corresponding to the respective methods.

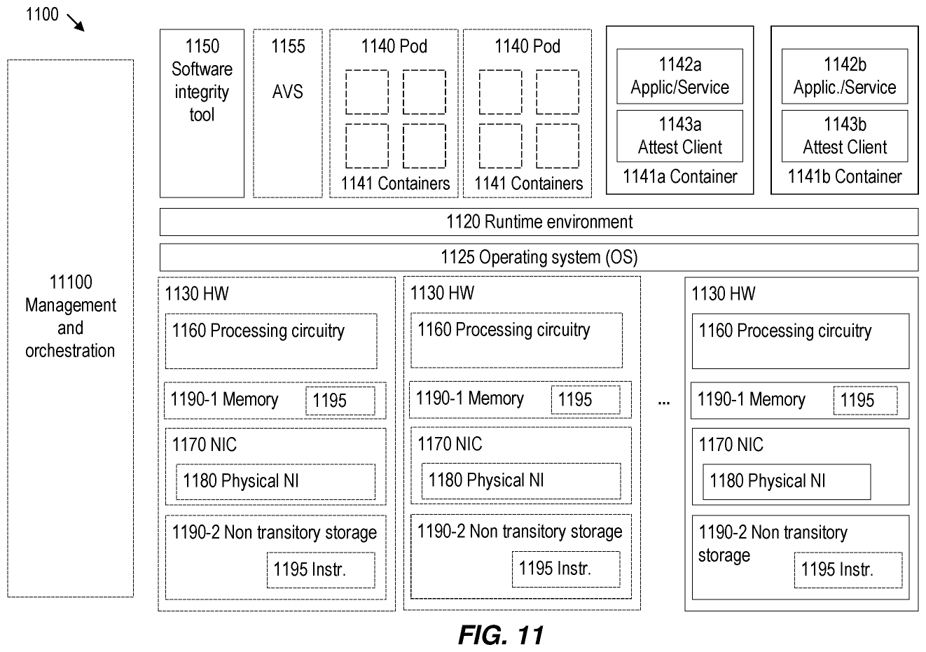

FIG. 11 is a schematic block diagram illustrating a host computing system 1100 of functions implemented by some embodiments.

In some embodiments, some or all of the functions described herein can be implemented as components executed in runtime environment 1120 hosted by one or more of hardware nodes 1130. Such hardware nodes can be computing machines arranged in a cluster (e.g., such as in a data center or customer premise equipment (CPE)) where many hardware nodes work together and are managed via management and orchestration (MANO) 11100, which, among others, oversees lifecycle management of applications 1140. Runtime environment 1120 can run on top of an operating system (OS) 1125, such as Linux or Windows, which runs directly on hardware nodes 1130.

Hardware nodes 1130 can include processing circuitry 1160 and memory 1190. Memory 1190 contains instructions 1195 executable by processing circuitry 1160 whereby application 1140 can be operative for various features, functions, procedures, etc. of the embodiments disclosed herein. Processing circuitry 1160 can include general-purpose or special-purpose hardware devices such as one or more processors (e.g., custom and/or commercial off-the-shelf), dedicated Application Specific Integrated Circuits (ASICs), or any other type of processing circuitry including digital or analog hardware components or special purpose processors. Each hardware node can comprise memory 1190-1 which can be non-persistent memory for temporarily storing instructions 1195 or software executed by processing circuitry 1160. For example, instructions 1195 can include program instructions (also referred to as a computer program product) that, when executed by processing circuitry 1160, can configure hardware node 1130 to perform operations corresponding to the methods/procedures described herein.

Each hardware node can comprise one or more network interface controllers (NICs)/network interface cards 1170, which include physical network interface 1180. Each hardware node can also include non-transitory, persistent, machine-readable storage media 1190-2 having stored therein software 1195 and/or instructions executable by processing circuitry 1160. Software 1195 can include any type of software including operating system 1125, runtime environment 1120, software integrity tool 1150, and containerized applications 1140.

Various applications 1142 (which can alternatively be called software instances, virtual appliances, network functions, virtual nodes, virtual network functions, containers, containerized applications, etc.) can be executed by host computing system 1100. Each application 1141 can be included in a corresponding container 1141, such as applications 1142a-b in containers 1141a-b shown in FIG. 11. Note that in some instances applications 1142 can represent services. Each container 1141 can also include an attest client 1143, such as attest clients 1143a-b in containers 1141a-B shown in FIG. 11.

In some embodiments, runtime environment 1120 can be used to abstract applications 1142 and containers 1141 from the underlying hardware nodes 1130. In such embodiments, processing circuitry 1160 executes software 1195 to instantiate runtime environment 1120, which can in some instances be a Docker Runtime. For example, runtime environment 1120 can appear like computing and/or networking hardware to containers and/or pods hosted by host computing system 1100.

In some embodiments, multiple application containers 1141 can be arranged in a pod 1140. In such embodiments, pod 1140 (e.g., a Kubernetes pod) can be a basic execution unit, i.e., the smallest and simplest unit that can be created and deployed in host computing system 1100. This may be the case, for instance, when multiple containers 1141 encapsulate services that are used are building blocks for a higher-level application, represented by pod 1140.

Each pod can include a plurality of resources shared by containers within the pod. For example, a pod can represent processes running on a cluster and can encapsulates container(s) (including applications/services therein), storage resources, a unique network IP address, and options that govern how the container(s) should run. In general, containers can be relatively decoupled from underlying physical or virtual computing infrastructure.

Attest clients 1143 can include, but are not limited to, various features, functions, structures, configurations, etc. of various attest client embodiments shown in various other figures and discussed in more detail above.

In addition to the applications 1140, a software integrity tool 1150 can also be run in the host computing system 1100 shown in FIG. 11. Software integrity tool 1150 can include, but is not limited to, various features, functions, structures, configurations, etc. of various software integrity tool embodiments shown in various other figures and discussed in more detail above.

In some embodiments, the host computing system can include an attestation verification system (AVS) 1155. For example, AVS 1155 can be executed on hardware nodes 1130 of host computing system 1100. Alternately, the AVS can be executed on hardware external to host computing system 1100, which may be similar to the hardware shown in FIG. 11. Moreover. AVS 1155 can include, but is not limited to, various features, functions, structures, configurations, etc. of various AVS embodiments shown in various other figures and discussed in more detail above.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the spirit and scope of the disclosure. Various embodiments can be used together with one another, as well as interchangeably therewith, as should be understood by those having ordinary skill in the art.

The term unit, as used herein, can have conventional meaning in the field of electronics, electrical devices and/or electronic devices and can include, for example, electrical and/or electronic circuitry, devices, modules, processors, memories, logic solid state and/or discrete devices, computer programs or instructions for carrying out respective tasks, procedures, computations, outputs, and/or displaying functions, etc., such as those that are described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM). Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

As described herein, device and/or apparatus can be represented by a semiconductor chip, a chipset, or a (hardware) module comprising such chip or chipset: this, however, does not exclude the possibility that a functionality of a device or apparatus, instead of being hardware implemented, be implemented as a software module such as a computer program or a computer program product comprising executable software code portions for execution or being run on a processor. Furthermore, functionality of a device or apparatus can be implemented by any combination of hardware and software. A device or apparatus can also be regarded as an assembly of multiple devices and/or apparatuses, whether functionally in cooperation with or independently of each other. Moreover, devices and apparatuses can be implemented in a distributed fashion throughout a system, so long as the functionality of the device or apparatus is preserved. Such and similar principles are considered as known to a skilled person.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In addition, certain terms used in the present disclosure, including the specification and drawings, can be used synonymously in certain instances (e.g., “data” and “information”). It should be understood, that although these terms (and/or other terms that can be synonymous to one another) can be used synonymously herein, there can be instances when such words can be intended to not be used synonymously.

1.-40. (canceled)

41. A method for a software integrity tool of a host computing system configured with a runtime environment arranged to execute containers that include applications, the method comprising:
based on an identifier of a container instantiated in the runtime environment, obtaining a container locator tag associated with the container and performing measurements on a filesystem associated with the container; and
sending, to an attestation verification system (AVS), a representation of the container locator tag and a result of the measurements.

42. The method of claim 41, further comprising:
monitoring for one or more events or patterns indicating that a container has been instantiated in the runtime environment; and
in response to detecting the one or more events or patterns, obtaining the identifier of the container that has been instantiated.

43. The method of claim 42, wherein monitoring for the one or more events is performed using an eBPF probe.

44. The method of claim 41, wherein performing measurements on the filesystem comprises computing a digest of one or more files stored in the filesystem associated with the container, wherein the digest is the result of the measurements sent to the AVS.

45. The method of claim 44, wherein performing measurements on the filesystem further comprises selecting the one or more files on which to compute the digest, wherein the selection is according to a digest policy of the host computing system.

46. The method of claim 41, wherein the identifier associated with the container is a process identifier (PID) and the filesystem associated with the container has a pathname that includes the PID.

47. The method of claim 41, wherein the representation of the container locator tag is one of the following: the container locator tag, or a digest of the container locator tag.

48. The method of claim 41, wherein one or more of the following applies:
the container locator tag is a random string; and
the container locator tag is obtained from a predefined location in the filesystem associated with the container.

49. The method of claim 41, further comprising digitally signing the representation of the container locator tag and the result of the measurements before sending to the AVS, wherein the digitally signing is based on key material that is accessible to the host computing system but is not accessible to containers configured to execute in the runtime environment.

50. A method for a container that includes an application, the container being configured to execute in a runtime environment of a host computing system, the method comprising:
in response to the container being instantiated in the runtime environment, generating a container locator tag and storing the container locator tag in association with the container;
subsequently receiving, from an attestation verification system (AVS), an attestation result indicating whether the AVS verified a filesystem associated with the container based on measurements performed by a software integrity tool of the host computing system; and
when the attestation result indicates that the AVS verified the filesystem associated with the container, preparing the application for execution in the runtime environment.

51. The method of claim 50, wherein the container also includes an attest client that generates and stores the container locator tag and receives the attestation result.

52. The method of claim 50, further comprising performing one or more of the following when the attestation result indicates that the AVS did not verify the filesystem associated with the container: error handling, and refraining from preparing the application for execution in the runtime environment.

53. The method of claim 50, wherein one or more of the following applies:
the container locator tag is a random string; and
the container locator tag is stored in a predefined location in the filesystem associated with the container.

54. The method of claim 53, further comprising sending a representation of the container locator tag to the AVS, wherein the attestation result is based on the representation of the container locator tag.

55. The method of claim 54, wherein the representation of the container locator tag sent to the AVS is one of the following: the container locator tag, or a digest of the container locator tag.

56. The method of claim 50, wherein the measurement results include a digest of one or more files stored in the filesystem associated with the container.

57. The method of claim 46, wherein the one or more files, on which the digest is based, are selected according to a digest policy of the host computing system.

58. A method for an attestation verification system (AVS) associated with a host computing system configured with a runtime environment arranged to execute containers that include applications, the method comprising:
receiving the following from a software integrity tool of the host computing system:
a representation of a container locator tag for a container instantiated in the runtime environment, and
results of measurements performed by the software integrity tool on a filesystem associated with the container;
based on detecting a match between the representation of the container locator tag and a previously received representation of the container locator tag, performing a verification of the filesystem associated with the container based on the results of the measurements;
sending, to the container, an attestation result indicating whether the AVS verified the filesystem associated with the container.

59. The method of claim 58, wherein performing the verification comprises:
comparing the results of the measurements with one or more known-good or reference values associated with the container; and
verifying the filesystem only when there is a match or correspondence between the results of the measurements and the one or more known-good or reference values.

60. The method of claim 58, wherein the previously received representation was received from an attest client included in the container.

61. The method of claim 58, wherein one or more of the following applies:
the container locator tag is a random string; and
the container locator tag is stored in a predefined location in the filesystem associated with the container.

62. The method of claim 58, wherein both the representation and the previously received representation are one of the following: the container locator tag, or a digest of the container locator tag.

63. The method of claim 58, wherein:
the representation of the container locator tag and the result of the measurements are digitally signed by the software integrity tool; and
performing the verification comprises verifying the digital signing based on key material that is accessible to the host computing system but is not accessible to containers configured to execute in the runtime environment.

64. A host computing system configured with a runtime environment arranged to execute containers that include applications, the host computing system comprising:
memory storing computer-executable software code for a software integrity tool and for the runtime environment; and
processing circuitry configured to execute the software code, wherein execution of the software code configures the host computing system to:
by a container, in response to being instantiated for execution in the runtime environment, generate a container locator tag, store the container locator tag in association with the container, and send a representation of the container locator tag to an attestation verification system (AVS);
by the software integrity tool, based on an identifier of the container, obtain a container locator tag associated with the container and perform measurements on a filesystem associated with the container; and
by the software integrity tool, send to the AVS a representation of the container locator tag and a result of the measurements;
by the container, receive from the AVS an attestation result indicating whether the AVS verified the filesystem associated with the container based on the measurements performed by the software integrity tool; and
by the container, when the attestation result indicates that the AVS verified the filesystem associated with the container, prepare the application included in the container for execution in the runtime environment.

65. The host computing system of claim 64, wherein:
the memory also include software code for the AVS; and
execution of the software code further configures the host computing system to, by the AVS, perform operations corresponding to the method of claim 58.

66. An attestation verification system (AVS) associated with a host computing system configured with a runtime environment arranged to execute containers that include applications, the AVS comprising:
memory storing computer-executable instructions; and
processing circuitry configured to execute the instructions, wherein execution of the instructions configures the AVS to:
receive the following from a software integrity tool of the host computing system:
a representation of a container locator tag for a container instantiated in the runtime environment, and
results of measurements performed by the software integrity tool on a filesystem associated with the container;
based on detecting a match between the representation of the container locator tag and a previously received representation of the container locator tag, perform a verification of the filesystem associated with the container based on the results of the measurements; and
send, to the container, an attestation result indicating whether the AVS verified the filesystem associated with the container.
